(19) United States
(12) Patent Application Publication
(10) Pub. No.: US 2022/0240064 A1
(43) Pub. Date: Jul. 28, 2022

(54) VEHICLE-SHARING SYSTEM AND METHOD FOR ACCESSING A VEHICLE FROM SUCH A SYSTEM

(71) Applicant: SIGFOX, LABEGE (FR)

(72) Inventors: Juan Carlos ZUNIGA, Montreal (CA); Ludovic LE MOAN, Pin Justaret (FR)

(21) Appl. No.: 17/616,640

(22) PCT Filed: Jun. 18, 2020
(86) PCT No.: PCT/EP2020/067012

§ 371 Date: Dec. 6, 2021

(30) Foreign Application Priority Data
Jun. 19, 2019 (FR) FR1906591

(51) Int. Cl. H04W 4/44; H04W 8/18

(52) U.S. Cl. CPC H04W 4/44; H04W 84/18; H04W 8/18

(57) ABSTRACT

A vehicle-sharing system includes a server having access to a database including information on subscription of a user to a carshare service. A terminal of the user includes a local database including a list of vehicles likely to be use. For each vehicle, information for establishing a communication with that vehicle. The terminal is configured to pair with a vehicle and to send to the vehicle a reference to the user's subscription of the vehicle-sharing service. The vehicle is configured to transmit the reference to the server. The server is configured to verify the subscription information of the user present in the database of the server from the transmitted reference. If the verification succeeds, server sends an authorization for access to the vehicle to remotely allow the user to access the vehicle.

### RELATED APPLICATIONS

This application is a § 371 application of PCT/EP2020/067012 filed Jun. 18, 2020, which claims priority from French Patent Application No. 19 06591 filed Jun. 19, 2019, each of which is incorporated herein by reference in its entirety.

### FIELD OF THE INVENTION

The present invention belongs to the field of systems for sharing vehicles between various users. In particular, the invention relates to a method and a system for accessing a vehicle shared by a user subscribing to a vehicle-sharing service.

### BACKGROUND OF THE INVENTION

A vehicle-sharing service, also known by the term carshare service or self-service vehicle service, is a system wherein vehicles are made available to a group of users who have taken out a subscription to said sharing service.

Rather than having a personal vehicle that is sometimes used only on rare occasions, a user of a vehicle-sharing service can access a vehicle that they finance, via their subscription, only for the duration they need. For the rest of the time, the vehicle can be used by other users subscribing to the sharing service. The use of a shared vehicle may for example be invoiced to the user according to the type of vehicle, the duration of the reservation, the distance travelled, etc.

So that only one user who has taken out a subscription to a vehicle-sharing service can access a shared vehicle of said service, it is necessary to implement methods for limiting access to a shared vehicle.

Among the existing vehicle-sharing systems, it is known that a user wishing to access a vehicle in a fleet of shared vehicles uses an application on their mobile telephone to identify a vehicle available in proximity to the geographical position where the user is located and to release access to said vehicle.

FIG. 1 schematically shows such a vehicle-sharing system 10 of the prior art. As illustrated on FIG. 1, the vehicle-sharing system 10 includes in particular a vehicle 13, a server 11 and a mobile telephone 14 of a user wishing to access the vehicle 13.

The server 11 has access to a database 12 wherein a list of vehicles belonging to the fleet of shared vehicles is stored. The geographical position of each vehicle is for example kept up to date in the database. The database 12 also includes subscription information for each user registered for the vehicle-sharing service.

A first communication link 15 between the mobile telephone 14 and the server 11 can be established, for example according to a first wireless communication system 150, for example a cellular system such as GSM, 3G or LTE. Information can then be exchanged between a mobile application installed on the mobile telephone 14 and the server 11. In particular, the application may enable the user to see, on a map displayed on the screen of the telephone, the location of the shared vehicles located in a geographical area close to the user. The user can also select a particular shared vehicle 13 and reserve it with the server 11. For this purpose, an identifier of the vehicle and information relating to the subscription of the user (for example an identifier of the user, a client number, etc.) are transmitted by the mobile telephone 14 to the server 11. The server 11 can then verify the subscription information of the user stored in the database from the subscription information received from the mobile telephone 14. If the verification succeeds, the server 11 creates a temporal authentication key enabling the user to release access to the vehicle 13. This temporal authentication key is sent on the one hand to the mobile telephone 14 over the first communication link 15 between the server 11 and the mobile telephone 14, and on the other hand to the vehicle 13 over a second communication link 16 between the vehicle 13 and the server 11 according to a second wireless communication system 160. The second wireless communication system 160 may be identical to or different from the first wireless communication system 150. A third communication link 17 between the mobile telephone 14 and the vehicle 13 is then established according to a third wireless communication system 170. On this communication link 17, the mobile telephone 14 can send to the vehicle 11 the temporal authentication key received from the server 11. If the authentication key received from the terminal 14 is identical to the authentication key received from the server 11, the vehicle 13 releases its access (for example an anti-theft device on the steering column of the vehicle 13 is unlocked). The third wireless communication 170 may be identical to or different from the first wireless communication system 150 and/or the second wireless communication system 150.

Such a solution does however have a cost for the user when the communications exchanged between the mobile telephone 14 and the server 11 or between the mobile telephone 14 and the vehicle 13 are paid. In particular, when the first wireless communication system 150 and/or the third wireless communication system 170 is a cellular system (GSM, 3G or LTE), and when the user is roaming outside the country for which they have taken out their mobile telephone contract, the cost of the communications on the communication links 15 and 17 may be particularly high. Furthermore, if the user is located in a system in which their telephone contract does not enable them to communicate, the user finds it impossible to use the shared-vehicle service.

### OBJECT AND SUMMARY OF THE INVENTION

The objective of the present invention is to remedy all or some of the drawbacks of the prior art, in particular those described above, by proposing a solution wherein a user does not need to establish a direct communication with the server of a vehicle-sharing service to reserve and access a vehicle.

For this purpose, and according to a first aspect, the present invention proposes a vehicle-sharing system. The vehicle-sharing system includes at least one vehicle, at least one terminal of a user wishing to access said vehicle, and a server having access to a database including information on subscription of said user to a vehicle-sharing service. The vehicle and the terminal each include a first communication module making it possible to establish a first communication link between the terminal and the vehicle according to a first wireless communication system. The vehicle also includes a second communication module making it possible to establish a second communication link between the vehicle and the server according to a second wireless communication system. The terminal is configured to identify the vehicle from a local database of the terminal. The local database includes in particular a list of vehicles likely to be used by the user and, for each vehicle in the list, information making it possible to establish a communication between said vehicle and the terminal on the first communication link. The terminal is configured to establish, on the first communication link, a pairing connection with the vehicle and to send to the vehicle a reference to the subscription of the user to the vehicle-sharing service. The vehicle is configured to transmit said reference to the server on the second communication link. The server is configured to verify the subscription information of the user present in the database of the server from the transmitted reference by the vehicle and, if the verification succeeds, to send to the vehicle, on the second communication link, an authorization for access to the vehicle in order to remotely allow the user to access the vehicle.

The information making it possible to establish a communication between the vehicle and the terminal is for example an identifier, an MAC (“medium access control”) address, an authentication key, etc. This information may be limited to a single particular parameter or consist of a combination of several different parameters. Such information can in particular make it possible to establish a secure reliable communication link between the terminal and the vehicle.

The reference to the subscription of the user is a data item that makes it possible to identify the subscription of the user from all the subscriptions stored in the database of the server. The reference to the subscription of the user enables the vehicle to interrogate the server on the status of the subscription. The reference to the subscription may be an identifier of the user (for example an email address), a client number, or a subscription number, etc.

With such provisions, and unlike the solutions of the prior art, there is no longer any need to establish a direct communication link, potentially expensive for the user, between the terminal and the server.

This is because, in the solution proposed, the vehicle fulfils the role of intermediary between the terminal and the server. A free ad hoc communication link that does not use an infrastructure can for example be used between the terminal and the vehicle. The cost relating to the communication link between the vehicle and the server for its part is not borne by the user. This cost can in fact be borne by the manager of the vehicle-sharing service.

In particular embodiments, the invention may furthermore include one or more of the following features, taken in isolation or in accordance with all the technically possible combinations.

In particular embodiments, the first wireless communication system and the second wireless communication system are distinct.

In particular embodiments, the second wireless communication system is a low-power wide-area network.

This is because, even if in the invention nothing obliges the first wireless communication system and the second wireless communication system to be distinct, it is however advantageous for the first communication system to offer a free short-range ad hoc wireless communication link, and for the second communication system to offer a long-range wireless communication link with low electrical consumption.

According to a second aspect, the present invention relates to a method for access to a vehicle by a user of a vehicle-sharing system. The vehicle-sharing system includes a server having access to a database including information on subscription of said user to a vehicle-sharing service. The vehicle is adapted to communicate with a user terminal on a first communication link according to a first wireless communication system. The vehicle is also adapted to communicate with the server on a second communication link according to a second wireless communication system. The method includes the following steps:
an identification of the vehicle by the terminal from a local database of the terminal, said local database including a list of vehicles likely to be used by the user and, for each vehicle in the list, information making it possible to establish a communication between said vehicle and the terminal on the first communication link,
a pairing between the terminal and the vehicle on the first communication link,
a sending, by the terminal, to the vehicle, on the first communication link, of a reference to the subscription of the user to the vehicle-sharing service,
a transmission of said reference by the vehicle to the server on the second communication link,
a verification, by the server, of the subscription information of the user present in the database of the server from the transmitted reference,
if the verification succeeds, a sending, by the server, to the vehicle, on the second communication link, of an authorization for access to the vehicle in order to remotely allow the user to access the vehicle.

In particular embodiments, the invention may furthermore include one or more of the following features, taken in isolation or in accordance with all the technically possible combinations.

In particular embodiments, the method further includes a prior step of loading the local database onto the terminal, said local database being associated with a geographical area in which the vehicles in the list stored in said local database are located.

According to a third aspect, the present invention relates to a server of a vehicle-sharing system. The server has access to a database including information on subscription to a vehicle-sharing service for at least one user wishing to access a shared vehicle. The server includes a communication module for communicating with said vehicle on a communication link between the vehicle and the server. The server is configured to receive, on said communication link, a reference to the subscription of the user transmitted by the vehicle, to verify the subscription information of the user present in the database of the server from said reference and, if the verification succeeds, to send to the vehicle, on said communication link, an authorization for access to the vehicle in order to remotely allow the user to access the vehicle.

According to a fourth aspect, the present invention relates to a computer program product for a server of a vehicle sharing system. The server has access to a database including information on subscription to a vehicle-sharing service for at least one user wishing to access a shared vehicle. The server is adapted to communicate with said vehicle on a communication link between the vehicle and the server. Said computer program product includes a set of program code instructions which, when they are executed by one or more processors of the server, configure the processor or processors for implementing the following steps:
receiving, on said communication link, a reference to the subscription of the user transmitted by the vehicle,
verifying the subscription information of the user present in the database of the server from said reference,
if the verification succeeds, sending to the vehicle, on said communication link, an authorization for access to the vehicle in order to remotely allow the user to access the vehicle.

According to a fifth aspect, the present invention relates to a vehicle of a vehicle sharing system. The system includes a server having access to a database including information on subscription to a vehicle-sharing service for at least one user wishing to access a shared vehicle. The vehicle includes a first communication module making it possible to establish a first communication between the vehicle and a terminal of the user according to a first wireless communication system. The vehicle also includes a second communication module making it possible to establish a second communication link between the vehicle and the server according to a second wireless communication system. Furthermore, the vehicle is configured to:
receive, on the first communication link, a reference to the subscription of the user to the vehicle-sharing service sent by the terminal,
transmit said reference to the server on the second communication link,
receive, on the second communication link, an authorization for access to the vehicle sent by the server if the subscription information of the user present in the database of the server is correctly verified from said reference.

According to a sixth aspect, the present invention relates to a computer program product for a control unit of a vehicle of a vehicle-sharing system. Said system including a server having access to a database including information on subscription to a vehicle-sharing service for at least one user wishing to access a shared vehicle. Said vehicle is adapted to communicate with a terminal of the user on a first communication link according to a first wireless communication system. The vehicle is also adapted to communicate with the server on a second communication link according to a second wireless communication system. Said computer program product includes a set of program code instructions which, when they are executed by one or more processors of the control unit, configure the processor or processors for implementing the following steps:
receiving, on the first communication link, a reference to the subscription of the user to the vehicle-sharing service sent by the terminal,
transmitting said reference to the server on the second communication link,
receiving, on the second communication link, an authorization for access to the vehicle sent by the server if the subscription information of the user present in the database of the server is correctly verified from said reference.

According to a seventh aspect, the present invention relates to a terminal of a user of a vehicle-sharing system. Said terminal includes a wireless communication module making it possible to establish a communication link between the terminal and a vehicle of the vehicle-sharing system. The terminal is furthermore configured to:
identify the vehicle from a local database of the terminal, said local database including a list of vehicles likely to be used by the user and, for each vehicle in the list, information making it possible to establish a communication between said vehicle and the terminal on the communication link,
establish, on the communication link, a pairing connection with the vehicle,
send to the vehicle a reference to the subscription of the user to the vehicle-sharing service.

A remote access to the vehicle is enabled by a server of the vehicle-sharing system if the subscription information of the user present in the database of the server is correctly verified by the server from said reference.

According to an eighth aspect, the present invention relates to a computer program product for a control unit of a terminal of a user of a vehicle sharing system. The terminal is adapted to communicate with a vehicle of the vehicle-sharing system on a wireless communication link. The computer program product includes a set of program code instructions which, when they are executed by one or more processors of the control unit, configure the processor or processors for implementing the following steps:
identifying the vehicle from a local database of the terminal, said local database including a list of vehicles likely to be used by the user and, for each vehicle in the list, information making it possible to establish a communication between said vehicle and the terminal on the communication link,
establishing, on the communication link, a pairing connection with the vehicle,
sending to the vehicle a reference to the subscription of the user to the vehicle-sharing service.

### BRIEF DESCRIPTION OF THE DRAWINGS

The invention will be understood better from a reading of the following description, given by way of non-limitative example and made with reference to FIGS. 1 to 6, which show:

FIG. 1 is a schematic representation of a vehicle-sharing system according to the prior art,

FIG. 2 is a schematic representation of a vehicle-sharing system according to the invention,

FIG. 3 is a schematic representation of a terminal of a user of the vehicle-sharing system according to the invention,

FIG. 4 is a schematic representation of a vehicle of the vehicle-sharing system according to the invention,

FIG. 5 is a schematic representation of the main steps of a method for access to a vehicle of a vehicle-sharing system according to the invention,

FIG. 6 is a message-sequence diagram representing the concatenation of the steps of a method for access to a vehicle of a vehicle-sharing system according to the invention.

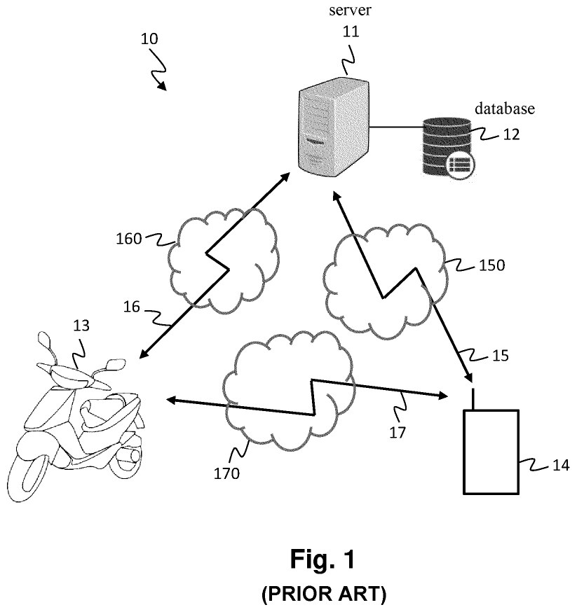

In these figures, references that are identical from one figure to another designate identical or similar elements. For reasons of clarity, the elements shown are not necessarily to the same scale, unless mentioned to the contrary.

### DETAILED DESCRIPTION OF AN EMBODIMENT OF THE INVENTION

As indicated previously, the present invention aims in particular to propose a vehicle-sharing system and a method for access to a shared vehicle for which a user does not need to establish a direct communication with a server of the vehicle-sharing service at the time when the user wishes to reserve and access a vehicle.

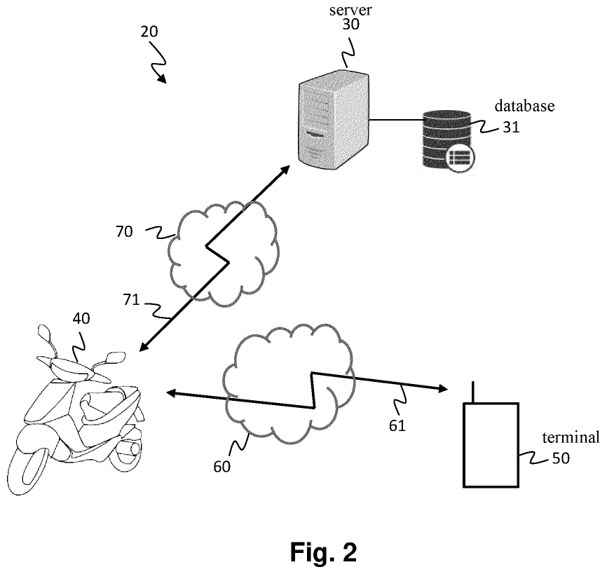

FIG. 2 schematically shows an example of a vehicle-sharing system 20 according to the invention. As illustrated in FIG. 2, the vehicle-sharing system 20 includes in particular at least one vehicle 40, a server 30 and at least one terminal 50 of a user wishing to access the vehicle 40.

In the remainder of the description, and by way of in no way limitative example, it is considered that the terminal 50 is a mobile telephone. It should however be noted that the terminal 50 could also be a connected bracelet, a connected watch, a simple chip card, or any other electronic device including the electronic components necessary for fulfilling the functions of the terminal 50.

In the example considered and illustrated in FIG. 2, the vehicle 40 is a motorcycle. It should however be noted that it could be a case of another type of vehicle, such as for example a car, a bicycle, an electric scooter, etc. The choice of a particular type of vehicle is merely a variant of the invention.

The server 30 has access to a database 31 in which subscription information is stored for each user subscribing to the vehicle-sharing service supported by the system 20. The database may for example be directly integrated in the server 30. According to another example, the database 31 may be a physical entity distinct from the server 30, and the server may communicate, in a conventional manner, with the database 31 to record information in the database 31 or to obtain information stored in the database 31.

In the database 31 of the server 30, the subscription information of a user subscribing to the vehicle-sharing service includes for example an identifier of the user (such as an email address, a client number, etc.), information on characteristics of the subscription (for example a maximum authorised mileage, or a maximum authorized number of borrowings of a vehicle, etc.), payment options (for example a bank card number, or a balance of the user account following a payment that was made by the user, etc.).

The server 30 includes one or more processors and storage means (magnetic hard disk, electronic memory, optical disc, etc.) wherein a computer program product is stored, in the form of a set of program code instructions to be executed for implementing at least some of the steps of a method for access to the vehicle 40 of the vehicle-sharing system 20.

The server 30 also includes a communication module to exchange messages with the vehicle 40.

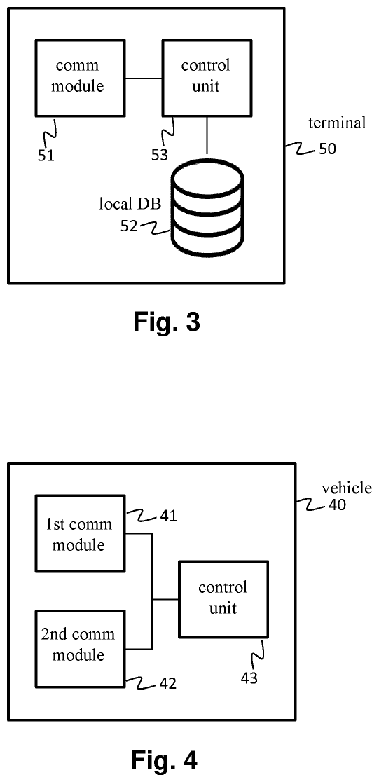

As illustrated in FIG. 3, the terminal 50 of a user includes a communication module 51 for establishing a first communication link 61 between the terminal 50 and the vehicle 40 according to a first wireless communication system 60.

Various choices are possible for the first wireless communication system 60, and the choice of a particular communication system is merely a variant of the invention. However, the first wireless communication system 60 can advantageously be selected to offer a free short-range ad hoc wireless communication link 61. “Ad hoc communication link” means that no network infrastructure is necessary for establishing the communication link between the terminal 50 and the vehicle 40. “Short range” means that the maximum distance between the terminal 50 and the vehicle 40 must be less than a few meters, or even a few tens of meters, so that messages can be exchanged between the terminal 50 and the vehicle 40 on the communication link 61. Using a short-range communication link 61 makes it possible in particular to ensure that the user is in proximity to the vehicle 40 (for example at less than five meters from the vehicle 40) at the moment when the user initiates a procedure for authorization of access to said vehicle. For example, the first wireless communication system 60 corresponds to the Bluetooth (based on IEEE 802.15.1), NFC (“Near Field Communication”, an extension to ISO/IEC 14443), ZigBee (based on IEEE 802.15.4), or Wi-Fi (based on the IEEE 802.11 standards) communication standard. Advantageously, the first wireless communication system 60 is a low energy consumption system, so that the terminal 50 and the vehicle 40 can use a relatively low-capacity battery that it is not necessary to change or recharge regularly.

As illustrated in FIG. 3, the terminal 50 furthermore includes a local database 52. The local database 52 includes in particular a list of vehicles likely to be used by the user and, for example vehicle in the list, information making it possible to establish a communication between said vehicle and the terminal 50 on the first communication link 61.

The local database 52 is for example downloaded onto the terminal 50 by the user. The local database 52 may include the list of all the vehicles of the vehicle-sharing service, whatever the geographical position of the vehicles. In a variant, the local database 52 may be associated with a geographical area in which the vehicles in the list stored in said local database 52 are located. Said geographical area may for example be a town, a region of a country, a country, or even a continent. Thus a user expecting to stay in a particular geographical area can download onto their terminal the local database associated with said geographical area so that, once they have arrived in the geographical area in question, the user can have access to the vehicles of the vehicle-sharing service located in this geographical area.

When the user has ended their stay in this geographical area, they can then delete the associated local database in order to release memory space in their terminal 50.

Optionally, the local database 52 may also include geographical positions of parking points of the vehicles in the car-sharing service. These geographical positions can assist the user in going to these parking points to borrow a vehicle.

The information contained in the local database 52 making it possible to establish a communication between the vehicle 40 and the terminal 50 includes for example an identifier, an MAC address, an authentication key, etc.

By way of example, if the information relating to a vehicle (MAC address, authentication key) can be encoded in forty bytes, a local database 52 of three megabytes (3 MB) can contain a list of forty-five thousand (45,000) vehicles.

It should be noted that the local database 52 is not downloaded onto the terminal 50 over a communication link between the server 30 and the terminal 50 at the moment when the user wishes to have access to the vehicle 40. The local database 52 is loaded upstream, before the user is located in proximity to the vehicle 40. The local database 52 may for example be loaded into the terminal 50 by means of a memory card inserted in the terminal 50. According to another example, the local database 52 may be downloaded by the terminal 50 via the internet at a moment and in a place where the user may have access to the internet with the terminal 50 free of charge.

As illustrated in FIG. 3, the terminal 50 also includes a control unit 53 including one or more processors and storage means (magnetic hard disk, electronic memory, optical disc, etc.) in which a computer program product is stored, in the form of a set of program code instructions to be executed for implementing at least some of the steps of a method for access to the vehicle 40 of the vehicle-sharing system 20.

The terminal 50 is in particular configured to identify the vehicle 40 from the local database 52. For example, each vehicle 40 of the car-sharing system 20 recurrently sends over the first communication link 61 a radio signal including a message including an identifier of the vehicle. The terminal 50 can decode the message and seek whether a vehicle in the list stored in the local database 52 has as its identifier the identifier contained in the message.

If the user is in proximity to a plurality of vehicles of the carshare service and the terminal 50 receives a plurality of radio signals sent by various vehicles, the terminal may decide to decode the message corresponding to the radio signal for which a parameter representing the quality of the radio signal has the highest value.

Such a parameter representing the quality of the radio signal may for example correspond to a power level received by the terminal 50 for said radio signal (“Received Signal Strength Indicator” or RSSI) or to a signal to noise ratio (SNR) of said radio signal.

According to another example, the terminal 50 can identify a vehicle 40 from an identifier corresponding to a serial number or to a registration number visible on the vehicle 40. The identifier can be indicated by the user to the terminal 50 via a graphical interface of the terminal 50. The terminal 50 can next seek whether a vehicle in the list stored in the local database 52 has as its identifier the indicated identifier.

According to yet another example, the terminal 50 can propose means (for example a photographic apparatus) for scanning a bar code or a QR (“Quick Response”) code visible on the vehicle 40 and corresponding to an identifier of the vehicle 40. The terminal 50 can next seek whether a vehicle in the list stored in the local database 52 has as its identifier the identifier corresponding to the scanned code.

Other methods for identifying the vehicle 40 from the local database 52 of the terminal 50 can be envisaged. The choice of a particular method is merely a variant of the invention.

The terminal 50 is also configured to establish, on the first communication link 61, a pairing connection with the vehicle 40 and to send to the vehicle 40 a reference to the subscription of the user to the vehicle-sharing service.

The pairing connection corresponds for example to an exchange of an authentication key between the terminal 50 and the vehicle 40. The authentication key to be used forms part of the information of the local database 52 associated with the vehicle 40 identified. This pairing connection makes it possible to establish a communication between the terminal 50 and the vehicle 40 over the first communication link 61.

The reference to the subscription of the user sent by the terminal 50 corresponds for example to an identifier of the user (email address, client number) or to an identifier of the subscription (subscription number).

As illustrated in FIG. 4, the vehicle 40 includes a first communication module enabling it to exchange messages with the terminal 50 over the first communication link 61.

The vehicle 40 also includes a second communication module 42 enabling it to exchange messages with the server 30 over a second communication link 71 according to a second wireless communication system 70.

Various choices are possible for the second wireless communication system 70, and the choice of a particular communication system is merely a variant of the invention. The second wireless communication system 70 may be identical to or distinct from the first wireless communication system 60. It should moreover be noted that, if the first wireless communication system 60 and the second wireless communication system 70 are identical, the first communication module 41 and the second communication module 42 may be a single physical entity.

However, the second wireless communication system 70 may advantageously be selected to offer a communication link 71 having a range of several kilometers and limited requirements in terms of electrical consumption, so that the vehicle 40 can exchange messages with the remote server 30 using a battery that it is not necessary to change or recharge regularly.

In particular embodiments, the second wireless communication system 70 is a wireless wide-area network with low electrical consumption known by the term LPWAN (“Low Power Wide Area Network”). Such a wireless communication system is an access network with long range (greater than one kilometer, or even greater than a few tens of kilometers), with low energy consumption (for example an energy consumption during transmission or reception of a message of less than 100 mW, or even less than 50 mW, or even less than 25 mW), and the bit rates of which are generally less than 1 Mbits/s. Such wireless communication systems are particularly adapted to applications involving connected objects (“Internet of Things” or IoT in the literature).

In particular embodiments, the wireless communication system 10 may be an ultra-narrow band communication system. “Ultra Narrow Band” or UNB in the literature means that the instantaneous frequency spectrum of the radio signals transmitted by the terminals has a frequency width of less than two kilohertz, or even less than one kilohertz. Such a system makes it possible to significantly limit the electrical consumption of the terminals when they communicate with the access network.

The server 30 is connected to the second wireless communication system 70. For example, the server 30 is directly connected to an access network of the second wireless communication system 70. According to another example, the server 30 and the access network of the second wireless communication system 70 are both connected to the internet, and a communication can thus be established between the vehicle 40 and the server 30 through both an access network of the second wireless communication system 70 and the internet.

As illustrated in FIG. 4, the vehicle 40 furthermore includes a control unit 43 including one or more processors and storage means (magnetic hard disk, electronic memory, optical disc, etc.) wherein a computer program product is stored, in the form of a set of program code instructions to be executed for implementing at least some of the steps of a method for access to the vehicle 40 of the vehicle-sharing system 20.

The vehicle 40 is in particular configured to transmit the reference to the subscription received from the terminal 50 to the server 30 over the second communication link 71.

The server 30 is configured to verify the subscription information of the user present in the database 31 of the server 30 from the reference to the subscription transmitted by the vehicle 40.

If the verification succeeds, the server 30 is configured to send to the vehicle 40, over the communication link 71, an authorization for access to the vehicle 40 in order to allow remote access of the user to the vehicle.

Verifying the subscription information of the user consists for example in ensuring that the payment means of the user (the balance of the account of the user, the bank card number, etc.) are valid, or that certain conditions for borrowing a vehicle are fulfilled (for example the maximum number of allowed borrowings or a maximum authorized mileage has not yet been reached by the user). The reference makes it possible to identify the subscription of the user among all the subscriptions for which information is stored in the database 31 of the server 30.

When the vehicle 40 receives an authorization for access to the vehicle 40, the control unit 43 of the vehicle 40 sends for example a command for deactivating an anti-theft device of the vehicle 40. The anti-theft device is for example configured to lock the steering column of the vehicle 40 when it is activated.

It is thus clear, as illustrated in FIG. 2, unlike the solutions of the prior art, that there is no need to establish a direct communication link between the terminal 50 and the server 30 at the moment when the user wishes to access the vehicle. In the solution proposed, the vehicle fulfils a role of intermediary (a role of proxy) between the terminal 50 and the server 30.

The solution proposed is thus simpler to implement since it does not require establishing communication between the terminal 50 and the server 30.

Furthermore, the solution proposed is potentially less expensive for the user, in particular if the user is in a situation of roaming in a foreign country. This is because, when a free ad hoc communication link 61 that does not use an infrastructure is used between the terminal 50 and the vehicle 40, the user does not have any communication cost to bear. The cost related to the communication link 71 between the vehicle 40 and the server 30 can in fact be borne by the manager of the vehicle-sharing service.

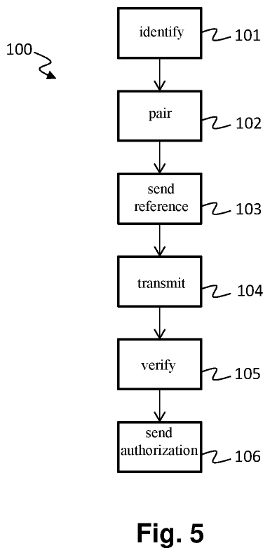

FIG. 5 schematically shows the main steps of a method 100 for access to a vehicle 40 of a vehicle-sharing system 20 according to the invention.

The various steps of this method 100 are for example implemented by the server 30, the vehicle 40 and the terminal 50 of the vehicle-sharing system 20 described previously with reference to FIG. 2.

The method 100 includes in particular the following steps:
an identification 101 of the vehicle 40 by the terminal 50 from a local database 52 of the terminal 50, said local database 52 including a list of vehicles likely to be used by the user and, for each vehicle 40 in the list, information making it possible to establish a communication between said vehicle 40 and the terminal 50 on the first communication link 61,
a pairing 102 between the terminal 50 and the vehicle 40 on the first communication link 61,
a sending 103, by the terminal 50, to the vehicle 40, on the first communication link 61, of a reference to the subscription of the user to the vehicle-sharing service,
a transmission 104 of said reference by the vehicle 40 to the server 30 on the second communication link 71,
a verification 105, by the server 30, of the subscription information of the user present in the database of the server from the transmitted reference,
if the verification 105 succeeds, a sending 106, by the server 30, to the vehicle 40, on the second communication link 71, of an authorization for access to the vehicle 40 in order to remotely allow the user to access the vehicle.

Optionally, the method 100 may also include a sending by the vehicle 40 of a confirmation to the terminal 50 if the access to the vehicle is authorized. This step is however not essential since an indication that the access to the vehicle is authorized may be visible directly on the vehicle. This step is not shown in FIG. 5.

As explained previously, it is important to note that, at the moment when the user wishes to access a vehicle, the identification 101 of the vehicle 40 by the terminal 50 from the local database 52 of the terminal 50 is made autonomously by the terminal, without there being an interaction between the terminal 50 and a remote server.

In particular embodiments, the method 100 furthermore includes a prior step of loading onto the terminal 50 of the local database 52. The local database 52 can store the list of all the vehicles of the vehicle-sharing service, whatever the geographical position of the vehicles. According to another example, the local database 52 can be associated with a particular geographical area in which the vehicles in the list stored in the local database 52 are located, and to which the user expects to go.

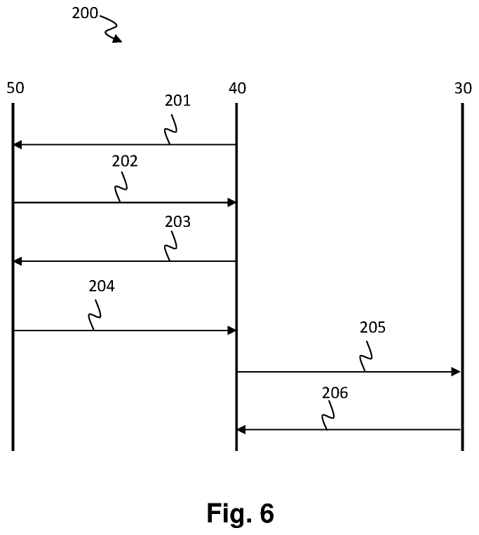

A message-sequence diagram 200 representing an example of concatenation of the steps of a method 100 for access to a vehicle 40 of a vehicle-sharing system 20 according to the invention is illustrated in FIG. 6.

As illustrated in FIG. 6, an identification message 201 is for example sent recurrently by the vehicle 40 to a terminal 50 of a user of the carshare service. The identification message 201 contains in particular an identifier of the vehicle 40.

The terminal 50 decodes the identification message 201 and, if a vehicle associated with the identifier contained in the identification message 201 is found in the local database 52 of the terminal 50 (identification step 101), the terminal 50 sends an authentication message 202 to the vehicle 40. The authentication message 202 contains for example an authentication key associated with the vehicle 40 identified and stored in the local data base 52.

The vehicle 40 verifies the authentication key and, if the verification succeeds, it sends an authentication confirmation message 203 (the set formed by the authentication message 202 and the authentication confirmation message 203 corresponds to the step 102 of pairing between the terminal 50 and the vehicle 40).

The terminal 50 is then in a position to send to the vehicle 40 an access request message 204 containing a reference to the subscription of the user to the vehicle-sharing service (sending step 103).

The vehicle 40 then transmits said reference to the server 30 in a new access request message 205 addressed to the server 30 (transmission step 104).

The server 30 verifies the subscription information of the user stored in the database 31 of the server 30 (verification step 105) from the transmitted reference. If the verification succeeds, the server 30 sends a message 206 of authorization of access to the vehicle 40 (sending step 106). Reception of the access authorization message 206 triggers the unlocking of an anti-theft system of the vehicle 40.

Optionally, the vehicle 40 may send a confirmation message to the terminal 50 if access to the vehicle is authorized. This message is not shown in FIG. 6.

In FIG. 6, the messages 201, 202, 203 and 204 exchanged between the terminal 50 and the vehicle 40 are exchanged over the first communication link 61. The messages 205 and 206 exchanged between the vehicle 40 and the server 30 are exchanged over the second communication link 71.

The above description clearly indicates that, through its various features and the advantages thereof, the present invention achieves the objectives set. In particular, the procedure for access to a vehicle of a carshare service proposed by the invention is both simple and advantageous in terms of communication cost for a user.

1-11. (canceled)

12. A vehicle-sharing system comprising:
at least one vehicle;
at least one terminal of a user wishing to access said at least one vehicle;
at least one processor-based server having access to a database comprising subscription information of said user to a vehicle-sharing service;
each of said at least one vehicle and each of said at least one terminal comprising a first communication module to establish a first communication link between said at least one terminal and said at least one vehicle according to a first wireless communication system, said at least one vehicle comprising a second communication module to establish a second communication link between said at least one vehicle and said at least one processor-based server according to a second wireless communication system;
wherein said at least one terminal is configured to identify said at least one vehicle from a local database of said at least one terminal, said local database comprising a list of vehicles likely to be used by said user and, for each vehicle in the list, information to establish a communication between said each vehicle in the list and said at least one terminal over the first communication link;
wherein said at least one terminal is configured to establish, over the first communication link, a pairing connection with said at least one vehicle and send to said at least one vehicle, a reference to a subscription of said user to the vehicle-sharing service;
wherein said at least one vehicle is configured to transmit said reference to said at least one processor-based server over the second communication link; and
wherein said at least one processor-based server is configured to verify the subscription of said user with the subscription information associated with said reference in the database of said at least one processor-based server and to transmit to said at least one vehicle over the second communication link, upon a successful verification of the subscription of said user, an authorization to access the vehicle to remotely allow said user to access said at least one vehicle.

13. The vehicle-sharing system of claim 12, wherein the first wireless communication system and the second wireless communication system are distinct.

14. The vehicle-sharing system of claim 13, wherein the second wireless communication system is a low power wide area network.

15. A method for accessing a vehicle by a user of a vehicle-sharing system, said vehicle-sharing system comprising a processor-based server having access to a database comprising subscription information of said user to a vehicle-sharing service, said vehicle being configured to communicate with a terminal of said user over a first communication link according to a first wireless communication system and for communicating with the server over a second communication link according to a second wireless communication system, the method comprises:
identification of said vehicle by the terminal from a local database of the terminal, the local database comprising a list of vehicles likely to be used by said user and, for each vehicle in the list, information to establish a communication between said each vehicle in the list and the terminal over the first communication link;
pairing between the terminal and said vehicle over the first communication link;
sending, to said vehicle over the first communication link by the terminal, a reference to a subscription of said user to the vehicle-sharing service;
transmission of said reference by said vehicle to the server over the second communication link;
verification, by the server, of the subscription of said user with the subscription information associated with said reference in the database of the server; and
transmission to said vehicle over the second communication link by the server, upon a successful verification of the subscription of said user, an authorization to access the vehicle to remotely allow said user to access said vehicle.

16. The method of claim 15, further comprising pre-loading the local database onto the terminal, the local database being associated with a geographical area wherein the vehicles in the list stored in said local database are located.

17. A processor-based server of a vehicle-sharing system, said server having access to a database comprising subscription information to a vehicle-sharing service for at least one user wishing to access a shared vehicle, said server comprising a wireless communication module to establish a communication link between the shared vehicle and said server, wherein said server is configured to:
receive, over the communication link, a reference to a subscription of said at least one user transmitted by the shared vehicle;
verify the subscription of said at least one user with the subscription information associated with said reference in the database of said server; and
transmit to the shared vehicle over the communication link, upon a successful verification of the subscription of said at least one user, an authorization to access the shared vehicle to remotely allow said at least one user to access the shared vehicle.

18. A non-transitory computer-readable medium comprising a set of program code instructions for managing the server of the vehicle-sharing system of claim 17, the set of program code instructions when executed by a processor of said server configures the processor to:
receive, over the communication link, said reference to the subscription of said at least one user transmitted by the shared vehicle;
verify the subscription of said at least one user with the subscription information associated with said reference in the database of said server; and
transmit to the shared vehicle over the communication link, upon a successful verification of the subscription of said at least one user, an authorization to access the shared vehicle to remotely allow said at least one user to access the shared vehicle.

19. A vehicle of a vehicle-sharing system, said system comprising a processor-based server having access to a database comprising subscription information to a vehicle-sharing service for at least one user wishing to access shared vehicles, said vehicle comprising a first communication module to establish a first communication link between said vehicle and a terminal of said at least one user according to a first wireless communication system, said vehicle comprising a second communication module to establish a second communication link between said vehicle and the server according to a second wireless communication system, wherein said vehicle is configured to:
receive, over the first communication link, a reference to a subscription of said at least one user to the vehicle-sharing service sent by the terminal;
transmit said reference to the server on the second communication link; and
receive, over the second communication link, an authorization for access to said vehicle transmitted by the server upon a successful verification of the subscription of said at least one user with the subscription information associated with said reference in the database of the server.

20. A non-transitory computer-readable medium comprising a set of program code instructions for a control unit of the vehicle of a vehicle-sharing system of claim 19, the set of program code instructions when executed by a processor of the control unit configures the processor to:
receive, over the first communication link, a said reference to the subscription of said at least one user to the vehicle-sharing service transmitted by the terminal;
transmit said reference to the server over the second communication link; and
receive, over the second communication link, an authorization for access to said vehicle transmitted by the server upon a successful verification of the subscription of said at least one user with the subscription information associated with said reference in the database of the server.

21. A terminal of a user of a vehicle-sharing system, the terminal comprising a wireless communication module to establish a communication link between the terminal and a vehicle of the vehicle-sharing system, wherein the terminal is configured to:
identify the vehicle from a local database of the terminal, said local database comprising a list of vehicles likely to be used by the user and, for each vehicle in the list, information to establish a communication between said each vehicle in the list and the terminal over the communication link;
establish, over the communication link, a pairing connection with the vehicle;
transmit to the vehicle, over the communication link, a reference to a subscription of the user to the vehicle-sharing service; and
remotely allow access to the vehicle when an authorization is received from a processor-based server of the vehicle-sharing system upon a successful verification of the subscription of the user with subscription information associated with said reference stored in a database of the server.

22. A non-transitory computer-readable medium comprising a set of program code instructions for a control unit of the terminal of a user of a vehicle-sharing system of claim 21, the set of program code instructions when executed by a processor of the control unit configures the processor to:
identify the vehicle from a local database of the terminal, said local database comprising the list of vehicles likely to be used by the user and, for each vehicle in the list, information to establish a communication between said each vehicle in the list and the terminal over the communication link;
establish, over the communication link, a pairing connection with the vehicle;
transmit to the vehicle, over the communication link, a reference to a subscription of the user to the vehicle-sharing service; and
remotely allow access to the vehicle when an authorization is received from a processor-based server of the vehicle-sharing system upon a successful verification of the subscription of the user with subscription information associated with said reference stored in a database of the server.
